(19) United States
(12) Patent Application Publication
(10) Pub. No.: US 2023/0385846 A1
(43) Pub. Date: Nov. 30, 2023

(54) AUTOMATED CUSTOMER SELF-HELP SYSTEM

(71) Applicant: Microsoft Technology Licensing, LLC, Redmond, WA (US)

(72) Inventors: Raymond Robert RINGHISER, Maple Valley, WA (US); Ravikumar Venkata- Seetharama BANDARU, Harrow (GB)

(21) Appl. No.: 17/828,203

(22) Filed: May 31, 2022

(51) Int. Cl. G06Q 30/00; G06F 9/451

(52) U.S. Cl. CPC G06Q 30/016; G06F 9/453

(57) ABSTRACT

Methods, systems, and computer programs are presented for providing self-help. One method includes operations for detecting a request for self-help for a user, and obtaining, using a first ML model for rule mining, a first score for a set of cases from a database of historical cases of self-help for aiding users. The method further includes an operation for obtaining, using a second ML model for similarity based on user information, a second score for each case based on a similarity between and an environment of the user requesting self-help and an environment of each case. Further, the method includes obtaining a combined score for each case based on the first score and the second score, and ranking the set of cases based on the combined score. The information for at least one of the cases is presented on a user interface (UI) based on the ranking.

### TECHNICAL FIELD

The subject matter disclosed herein generally relates to methods, systems, and machine-readable storage media for providing automated help to a person using a software application.

### BACKGROUND

Application vendors provide self-help options to users of the application, so these users can solve their application-related problems by themselves. For example, if a user is not able to connect a Bluetooth keyboard to a personal computer (PC), instead of having to engage with a support agent, the application makes it easy for the user to troubleshoot the problem using automated self-help. The success of self-help is important because having to engage with customer support is more costly for the application vendor, and sometimes more costly for the user also.

However, self-help systems sometimes are not able to troubleshoot the problem automatically, and sometimes they provide information that is not helpful. Sometimes self-help relies on simple text searches for the problem description entered by the user, but this basic approach may ignore many factors, such as data about the user and the environment of the user (e.g., PC model and application version ID).

At times, users feel frustrated when the help system does not take into consideration the information about the user that is already known, or that should be known, asking users to enter information about themselves and the computing environment that they are using.

As a result of less-than optimal self-help, the user may be given useless information to solve the same problem (e.g., insert a row in a table) by giving help information for a different application (e.g., help for using a spreadsheet when the user is using a word processor). This increases user frustration and lowers user satisfaction.

### BRIEF DESCRIPTION OF THE DRAWINGS

Various of the appended drawings merely illustrate example embodiments of the present disclosure and cannot be considered as limiting its scope.

FIG. 1 is a sample environment for implementing embodiments.

FIG. 2 illustrates the architecture for automating contextual customer self-help, according to some example embodiments.

FIG. 3 is a high-level flowchart of a method for finding similar cases, according to some example embodiments.

FIG. 4 illustrates an example of rule mining for predicting cases that may occur with a given probability, according to some example embodiments.

FIG. 5 is a flowchart of a method for using rule mining for case prediction, according to some example embodiments.

FIG. 6 illustrates the training and use of a machine-learning model for finding causes, according to some example embodiments.

FIG. 7 illustrates the training and use of a machine-learning model for rule mining, according to some example embodiments.

FIG. 8 illustrates the training and use of a machine-learning model for user context, according to some example embodiments.

FIG. 9 is a flowchart of a method for recommending self-help solutions, according to some example embodiments.

FIG. 10 illustrates the ranking process for selecting self-help options, according to some example embodiments.

FIG. 11 is a flowchart of a method for providing automated user self-help, according to some example embodiments.

FIG. 12 is a flowchart of another method for providing automated user self-help, according to some example embodiments.

FIG. 13 is a block diagram illustrating an example of a machine upon or by which one or more example process embodiments described herein may be implemented or controlled.

### DETAILED DESCRIPTION

Example methods, systems, and computer programs are directed to providing automated customer self-help. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The system for Automating Contextual Customer Self-Help (ACCSH) is designed for retrieving customer information, finding similar cases, identifying self-help options, and presenting self-help suggestions. ACCSH connects relevant customer account information, environmental details, and real-time support data for a better self-help experience with high resolution success rates.

One general aspect includes a method that includes operations for detecting a request for self-help for a user, and for obtaining, using a first machine-learning (ML) model for rule mining, a first score for each case from a plurality of cases from a database of historical cases of self-help for aiding users. The method further includes an operation for obtaining, using a second ML model for similarity based on user information, a second score for each case based on a similarity between and an environment of the user requesting for self-help and an environment of each case. Further, the method includes obtaining a combined score for each case from the plurality of cases based on the first score and the second score. The plurality of cases is ranked based on the combined score. The method further includes an operation for causing presentation on a user interface (UI) of information, for at least one of the plurality of cases, based on the ranking. In some cases, a third score is obtained, using a third machine-learning (ML) model for text similarity, for each case from the plurality of cases and used for the ranking. The third score is based on a semantic similarity between each case and the request for self-help.

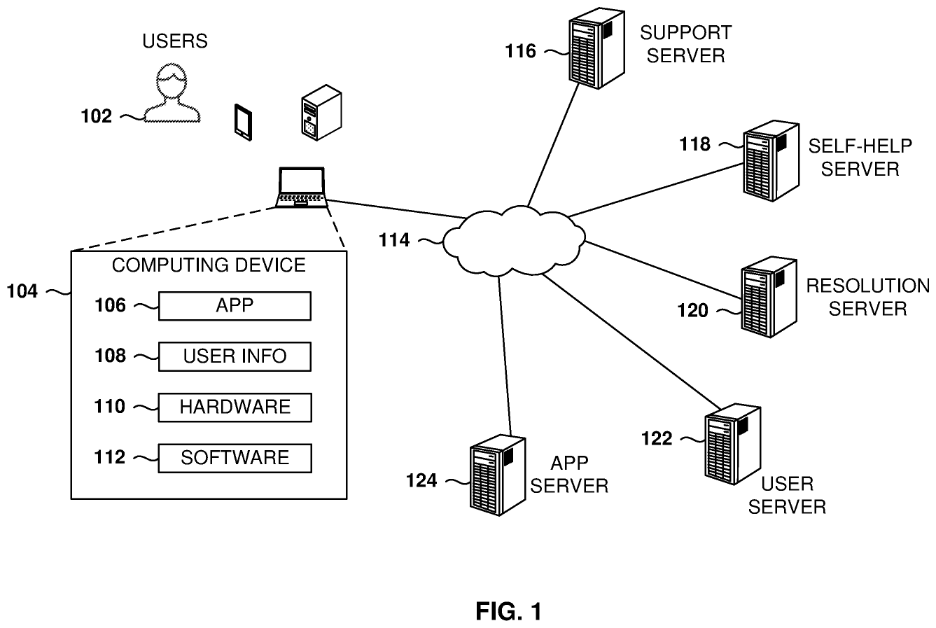

FIG. 1 is a sample environment for implementing embodiments.

Users 102 utilize computing devices 104 (e.g., phone, laptop, PC, tablet) to use a software application 106 (also referred to herein as app), which may be executing on the computing device 104 or on a remote server (e.g., app server 124) with the computing device providing a user interface. The computing device 104 may use a network 114, such as the Internet, to access multiple servers.

In some example embodiments, the computing device 104 includes, among other modules, the app 106, user information 108 (e.g., username, login name, user address, user phone number), a certain hardware 110, and other software 112. In some cases, the app 106 may not be included in the computing device 104 as the app is executed remotely on the app server 124, and a web browser may be used to access a user interface provided by the app server 124.

Further, a support server 116 provides support to the users 102 related to the app 106. A self-help server 118 provides self-help functionality to assist the user in problem resolution in an automated way without requiring the participation of support agents. For example, the self-help server 118 may provide troubleshooting tools to solve network connectivity problems, hardware connectivity problems, access to features, etc.

A resolution server 120 keeps track of problems previously solved by users, either via self-help or with the assistance or support agents. The information regarding resolution of problems is used to improve the self-help ability of the ACCSH. A user server 122 manages the interaction with users that access the app, such as user profiles, licenses, logins, passwords, etc.

When a user 102 has a problem, the user may ask the ACCSH (e.g., from the app 106) for help, and the ACCSH provides self-help support to assist the user 102 to solve problems without requiring a call to customer support. More details are provided below with reference to methods for improving the self-help available to users in order to increase the success rate of the self-help given, which results in an improvement in customer satisfaction and the reduction of support costs for the app provider.

Some embodiments are described with reference to users accessing Microsoft Windows™, but the same principles may be used to other environments and operating systems, such as mobile environments, Google environments, Apple environments, Unix environments, etc.

It is noted that the embodiments illustrated in FIG. 1 are examples and do not describe every possible embodiment. Other embodiments may utilize different servers, combine the functionality of one or more servers into one, divide the functionality of one server into multiple servers in a distributed fashion, etc. The embodiments illustrated in FIG. 1 should therefore not be interpreted to be exclusive or limiting, but rather illustrative.

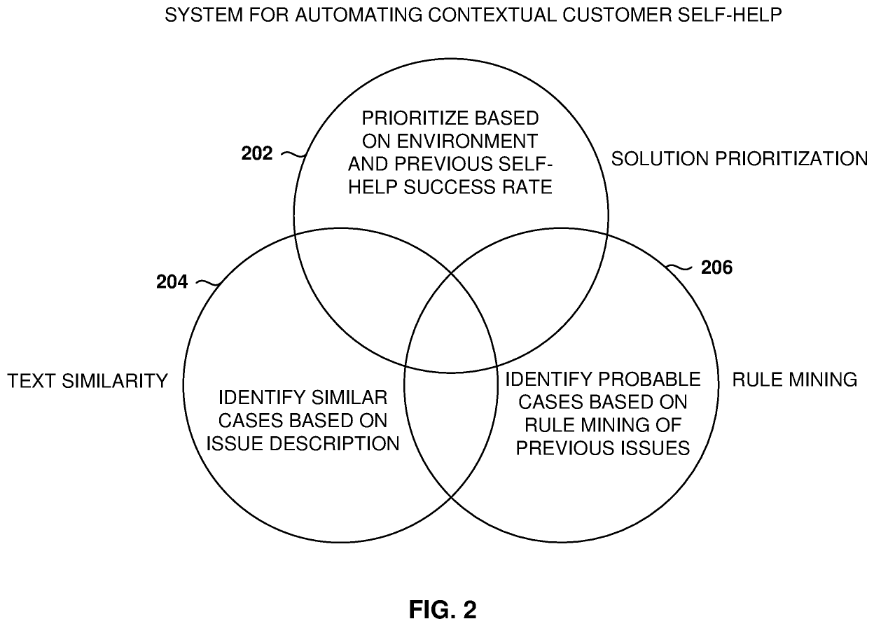

FIG. 2 illustrates the architecture of ACCSH, according to some example embodiments. One of the goals of ACCSH is to present the most relevant, contextual self-help content so the user can self-solve a problem. There are three interesting facts related to technical support. First, users prefer the ability to self-solve versus the need to interact with a human on the phone or the computer. Second, the success of a user's interaction with self-serve digital assets is improved substantially if the information presented is personalized to their needs, environment, and details (for example, account information, OS version, PC model, etc.). Third, the more technical a user's question or issue is, the more important fact number two is applicable.

To eliminate the need for a human to be involved in a support situation, the ACCSH system retrieves, surfaces, and anticipates the relevant user account and environment details, including technical information related to the case.

ACCSH connects relevant user account information, environmental details, and real-time support data. Information protected by company, industry, or legal industry requirements (for example, social security numbers, email addresses, phone numbers, etc.) are tagged and obfuscated before presentation to protect privacy. Environmental details refer to the specific products, services, versions, builds, etc., a user has purchased or licensed, and is using.

ACCSH integrates available information, in real time, to tailor each response to the user. A sample analogy is for a customer entering a high-end restaurant. Upon entry, the maitre d' determines whether she recognizes and knows the customer. When the maitre d' realizes the customer is a long-time patron, the maitre d' scans her memory for everything she knows about the customer. The maitre d' may recall the customer prefers a particular table by the window in the front of the restaurant, near a window, the customer has a shellfish allergy, received an incorrect bill during her last visit, prefers steak medium-rare, and enjoys a particular vintage of red wine. Upon recalling these details, the maitre d' then recalls that the restaurant recently installed new stoves and the chefs have been having difficulty getting the steak temperatures accurate and that the restaurant is currently out of the particular vintage of wine the customer prefers. With all this in mind, the maitre d' speaks thanks the customer for returning to the restaurant, despite the bill gaffe during the last visit, and recommends a highly rated chicken dish along with a red wine that closely matches the out-of-stock wine she would generally request. Similarly, ACCSH aims at delivering this highly customized user experience in a technical support application.

At a high-level, ACCSH includes three components: solution prioritization 202, text similarity 204, and rule mining 206. Solution prioritization 202 is for prioritizing solutions for self-help based on the environment (e.g., user information, configuration, software version) and the success rate of previous self-help given to users. The success rate is a ratio of the number of cases where the user was able to solve the problem divided by the total number of cases where the users received instructions for self-help.

In some example embodiments, the solution prioritization 202 filters cases (previous self-help events) based on the configuration and ranks the cases based on a multi-level ensemble of different filtering techniques based on the success rate of previous cases.

One of ACCSH's goal is to provide the best self-help solution based on the information about the user and about the problem. By taking into consideration the information known about the user, it is possible to select better possible solutions while minimizing the burden on the user to provide additional information. For example, ACCSH may know that a user has a Microsoft Surface™ device, a Bluetooth keyboard, and a subscription to Microsoft 365™, so ACCSH uses this information to sort and rank possible self-help solutions for this user. A self-help solution is a set of instructions provided to the user for solving the problem.

In some example embodiments, text similarity 204 is used to identify previous cases that have a problem description similar to the problem description entered by the user. Text similarity refers to how similar two blocks of text are. In some example embodiments, text similarity 204 is used to select a predefined number of the top similar cases based on a score provided by an ML model based on the semantic similarity between the text input and previous case descriptions. The score is a numerical value (e.g., in the range zero to one) that ranks how similar the text input is to the previous case descriptions.

Rule mining 206 is the process used to identify probable causes based on previous issues, that is, identify previous cases where users faced similar problems and pinpoint the cause of the problem in the previous cases.

Rule mining, also referred to as association rule mining, is a method for finding frequent patterns, correlations, associations, or causal structures from data sets found in databases. Given a set of transactions, rule mining aims to find the rules that predict the occurrence of a specific item based on the occurrences of the other items in the transaction. That is, in a given transaction with multiple items, rule mining tries to find the rules that govern how such items are often bought together. For example, peanut butter and jelly are often bought together because a lot of people like to make peanut butter and jelly sandwiches.

In some example embodiments, rule mining is used to analyze the data regarding previous cases (e.g., the problem description and the problem resolution) to find out the problem for the current case based on the similarity with previous cases.

ACCSH integrates available information, in real time, to tailor each response to the user. ACCSH leverages Machine Learning (ML) algorithms to create multi-level information connections, make on-demand decisions, and learn with each interaction. These connections occur across one or more of the following dimensions:
User recognition: Upon user authentication, ACCSH retrieves account data for the user, including available name, product, subscription or purchase history, subscription renewal timelines and incentives, and up- and cross-sell opportunities.
Environment details: ACCSH retrieves details from the user's previous support history, including the specific versions and details of each product/subscription, local environment details (e.g., particular OS and build) of the equipment used by the user, and any available details about user peripherals.
New details: ACCSH asks the user whether they are looking for a solution for the product and environment specifics retrieved above, and whether ACCSH can scan their local environment to update its information to better identify the needs of their current situation. If the user grants access, ACCSH updates the recorded user details with relevant operating systems, products, versions, builds and associated peripheral details. If the user does not grant access, ACCSH informs the user it will rely on known product and environment details from previous interactions.
Pattern matching: Once the user's technical environment details are known, ACCSH scans the support case database for all support tickets matching the user's environment.
Issue description: ACCSH either queries the user to describe the current issue or intakes this information from text or other fields already presented to the user.
Pattern matching: With the user's issue or question known, ACCSH scans the support cases identified as matching the user's environment, looking for issues or questions that match the details the user provided.
Prioritizing: With the historical support cases identified, ACCSH analyzes a range of case data, such as frequency of each issue, how recent each issue is, etc., and determines which of the successfully closed cases have the highest likelihood of matching the user's problem.
Self-serve digital asset matching: ACCSH performs three operations. First, ACCSH matches help articles that were used by the support engineer or advocate to resolve each of the related support cases in the previous step. Second, ACCSH performs text-matching analysis across self-serve digital assets added or updated after the most recent related support case occurrence. The matching self-serve digital assets are prioritized according to their calculated value and impact on previous related cases. Third, if ACCSH does not find self-serve digital assets with sufficient success, ACCSH automatically opens a ticket with the associated work assignment system for a support asset to be created to address the issue. ACCSH also includes relevant scale and scope details of the environment details and frequency and volume of the noted issue.

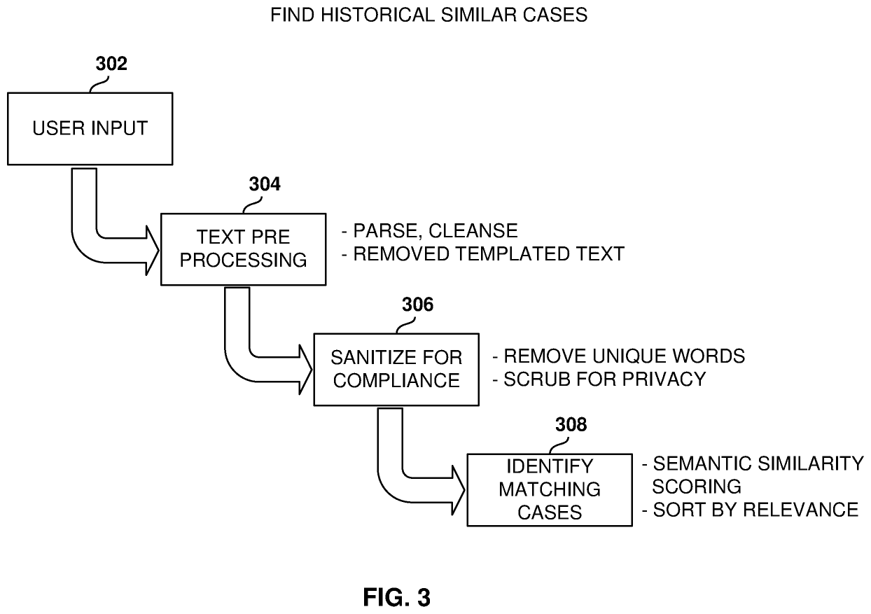

FIG. 3 is a high-level flowchart of a method for finding similar cases, according to some example embodiments. One goal is to present the user with related historical requests that are similar to the user's problem. For example, cases for the same product or feature and support topic, cases for the same product or feature but different support topic, and cases for similar product or feature and support topic. A request is something asked for by a user, such as asking for assistance in solving a problem that the user has found.

At operation 304, the user input 302 is preprocessed by analyzing the text entered by the user. For example, the text is parsed, cleansed of erroneous words, and edited to remove text (e.g., templated text provided by the app).

From operation 304, the method flows to operation 306 to sanitize the preprocessed text for compliance with ACCSH guidelines. For example, some words may be removed (e.g., duplicates, fillers), and the text is anonymized by removing user information to preserve user privacy.

Once the text is sanitized, operation 308 is performed to identify matching cases that will provide an insight on the problem and the possible solution. In some example embodiments, operation 308 includes calculating a semantic similarity score between the sanitized text and the new problem description. The results are then sorted by relevance according to the similarity score, and one or more of the topmost relevant cases are presented as possible solutions to the user. The user may then select one or more of the choices for self-help. In some cases, ACCSH automatically activates the solution for the similar case with the highest relevance score.

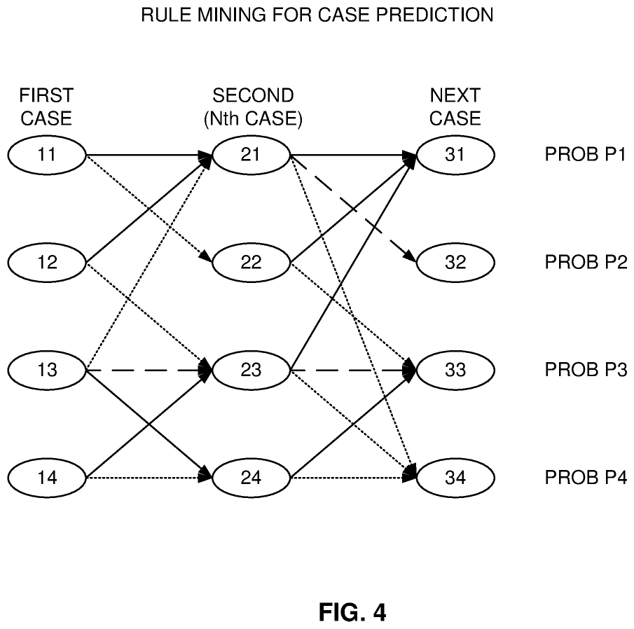

FIG. 4 illustrates an example of rule mining for predicting cases that may occur with a given probability, according to some example embodiments.

Rule mining is used for predicting the propensity of the user to experience a support issue based on the analysis of the sequence of past cases. The prediction of the next problem is based on what other similar users have faced before. The insight is used to prevent, or proactively solve, the likely next case, thereby resulting in a lower number of support cases entered in the system.

One example would be, “90 percent of users that raised case A and case B also raised case C later.” If case C can be avoided with minor incremental work, a support agent can fix the problem so case C will not happen. Additionally, the user may be notified about the possibility of case C happening with information on how to avoid its occurrence. For example, ACCSH may present options from a repository of self-help solutions, such as a diagnostic, a self-help article, a configuration guideline, etc. The most relevant suggestion, or suggestions, are presented to the user.

The illustrated example shows how a user may run into a first case 11 (e.g., an Xbox playing a certain game at level 2), then the user progressed (e.g., user advanced to level 3) and run into problem 21 with a certain probability, while other users run into problem 22. The process repeats and some of the users that run into problem 22 run into problem 33 with a probability P3, etc. Although the illustration shows three levels in the chain of cases, the number of cases in the chain may be larger, and the number of possibilities at each stage may also be larger or smaller.

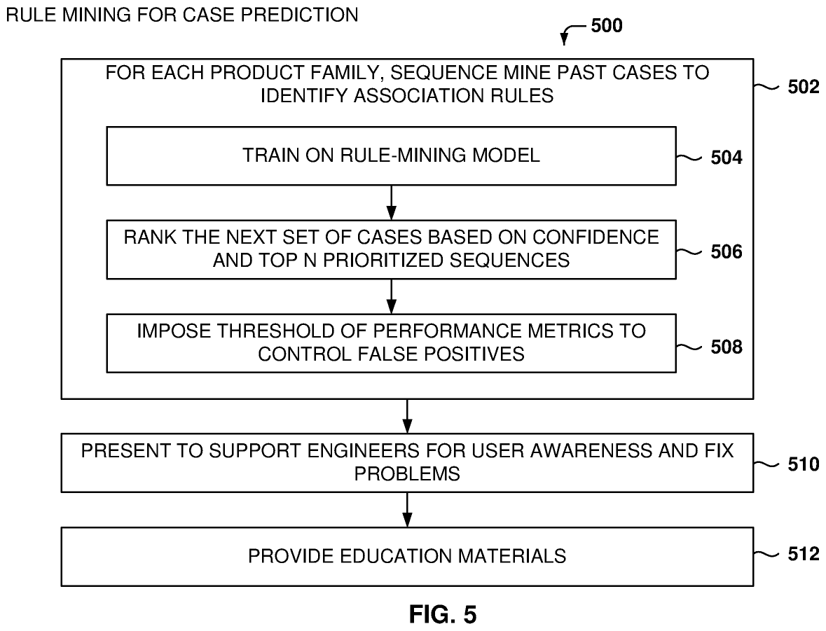

Details about the process are provided below with reference to FIG. 5. In the end, the system determines that some users will run into case 31 with a probability P1, case 32 with a probability P2, case 33 with a probability P3, case 34 with a probability P4, etc. These probabilities may be used to identify problems with a high probability of occurrence, such as those cases with a probability greater than a predetermined threshold probability value.

FIG. 5 is a flowchart of a method 500 for using rule mining for case prediction, according to some example embodiments. At operation 502, for each product family, the method performs sequenced mining of past cases to identify association rules.

A sequence s is defined as a set of ordered items denoted by (s₁, s₂, . . . , sₙ). The goal of sequence mining is to discover interesting patterns in data with respect to some subjective or objective measure of how relevant the pattern is. Typically, sequence mining involves discovering frequent sequential patterns with respect to a frequency support measure. Several algorithms for sequence mining are available, and any of these algorithms may be used for operation 502.

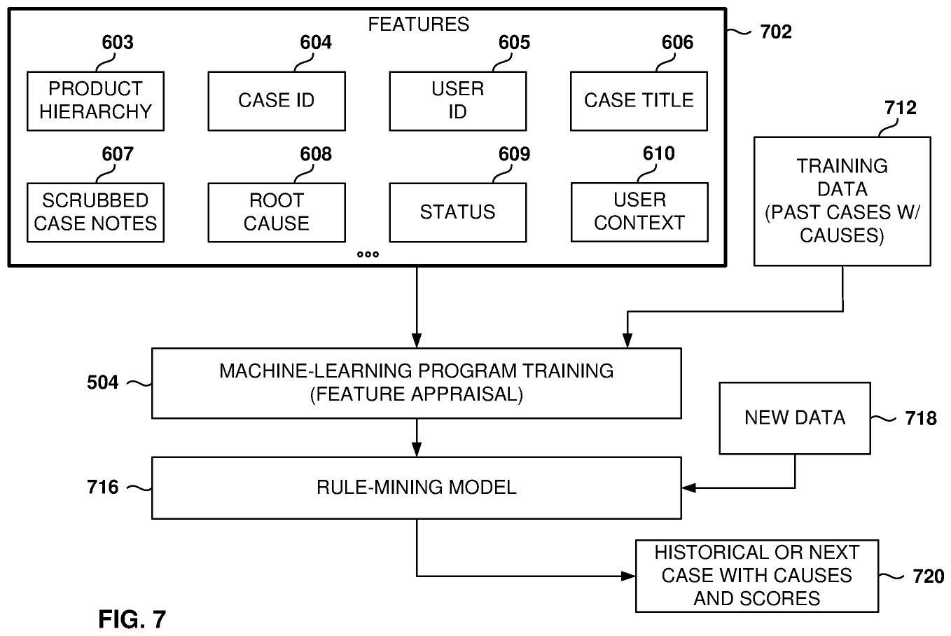

Operation 502 includes operations 504, 506, and 508. At operation 504, a rule mining model is trained, as described in more detail with reference to FIG. 7. At operation 506, the possible next cases are ranked based on the confidence level (e.g., relevance score) and a predetermined number N of the top sequences prioritized by their relevance score.

At operation 508, a threshold is imposed for the performance metrics used to control the reliability of the system. The threshold is used to rule out possible sequences identified in operation 506, such as sequences that may be false positives and are not relevant to the user problem. The threshold is tunable in order to control the number of false positives, while not eliminating relevant possible future cases.

At operation 510, the list of possible next cases is presented, such as to support engineers that handle problems and work on fixing those problems for users. In some embodiments, the possible cases may also be presented to the user. At operation 512, education materials, or some other relevant self-help information, associated with the potential possible cases are presented to the user.

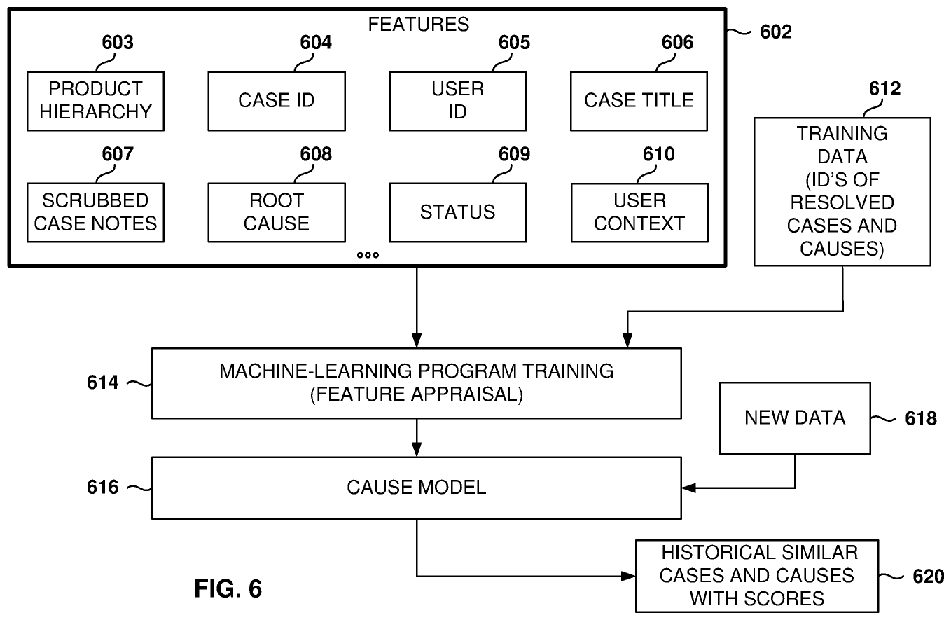

FIG. 6 illustrates the training and use of a machine-learning model, according to some example embodiments. In some example embodiments, an ML model, referred to as a cause model 616, is utilized to find historical similar cases to a given case faced by a user and provide a relevance score indicating how relevant the suggested similar case is to the user's case.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model from example training data 612 in order to make data-driven predictions or decisions expressed as outputs 620 or assessments. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

The training data 612 comprises examples of values for the features 602. In some example embodiments, the training data comprises labeled data with examples of values for the features 602 and labels indicating the outcome, such as a list of identifiers (IDs) of previous cases and a score indicating the relevance of each case. In some example embodiments, the training data 612 includes labeled data, which is known data for one or more identified features 602 and one or more outcomes, such as previous cases, outcome, and route cause. The machine-learning algorithms utilize the training data 612 to find correlations among identified features 602 that affect the outcome.

A feature 602 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 602 may be of different types and include at least one of product hierarchy 603, case ID 604, user ID 605, case title 606, scrubbed case notes 607, root cause 608, status 609, or user context 610. The product hierarchy 603 defines details about the product (e.g., product version, product name); the case ID 604 is a unique identifier for the case used by ACCSH (e.g., as stored in the database of historical cases); the user ID 605 is a unique identifier for the user involved in the case; the case title 606 is a short text description of the case; the scrubbed case notes 607 includes the case notes provided by the support engineer, and sometimes the user, scrubbed of confidential and identifying information to protect privacy; the root cause 608 is a description of the cause found for the problem; the status 609 indicates is the case is open or closed and if the case has been resolved or not; the user context 610 includes information about the user and information about the computer equipment used by the user.

During training 614, the ML program, also referred to as ML algorithm or ML tool, analyzes the training data 612 based on identified features 602. The result of the training 614 is the cause ML model 616 that is capable of taking inputs to produce assessments.

A Natural Language Processing (NLP) ML algorithm may be used. In some example embodiments, the ML algorithm is based on semantic similarity which is the similarity between two classes of objects in a taxonomy. A class C₁ in the taxonomy is considered to be a subclass of C₂ if all the members of C₁ are also members of C₂. Therefore, the semantic similarity between two classes is based on how closely they are related in the taxonomy. In connectionist models, the semantics of words are represented as patterns of activations, or banks of units representing individual semantic features. Semantic similarity is then the amount of overlap between different patterns, hence these models are related to the spatial accounts of similarity. However, the typically nonlinear activation functions used in these models allow virtually arbitrary re-representations of such basic similarities.

The ML algorithms explore many possible functions and parameters before finding what the ML algorithms identify to be the best correlations within the data; therefore, training may make use of large amounts of computing resources and time.

When the cause ML model 616 is used to perform an assessment, new data 618 is provided as an input to the cause ML model 616, and the cause ML model 616 generates the output 620. For example, when a new case is identified for a user, the data about the case (e.g., user information and case information) are input to the cause ML model 616, which generates as the output 620 a set of historical similar cases to the new case and a relevance score indicating how relevant the suggested similar case is to the new case. In some example embodiments, the cause ML model 616 is configured to receive as input a text of the request for self-help and provide the output 620 comprising cases from the database of historical cases and respective scores. The historical cases refer to previous requests of users for self-help assistance.

In some example embodiments, results obtained by the cause ML model 616 during operation (e.g., outputs 620 produced by the model in response to inputs) are used to improve the training data 612, which is then used to generate a newer version of the model. Thus, a feedback loop is formed to use the results obtained by the model to improve the model.

FIG. 7 illustrates the training and use of a machine-learning model for rule mining, according to some example embodiments. In some example embodiments, an ML model, referred to as the rule-mining model 716, is utilized to find a list of historical cases similar to the new case involving a user, and/or a list of possible cases that may occur after the new case.

In some example embodiments, the ML algorithm is an Apriori algorithm, which is based on association rule learning. Association rule learning is a rule-based ML method for discovering interesting relations between variables in large databases. It is intended to identify strong rules discovered in databases using some measures of interestingness. In any given transaction with a variety of items, association rules are meant to discover the rules that determine how or why certain items are connected.

The Apriori algorithm identifies the frequent individual items in the database and extends them to larger and larger item sets, as long as those item sets appear sufficiently often. The name of the algorithm is Apriori because it uses prior knowledge of frequent itemset properties. Apriori uses a bottom-up approach, where frequent subsets are extended one item at a time (a step known as candidate generation), and groups of candidates are tested against the data. The Apriori algorithm terminates when no further successful extensions are found. The Apriori algorithm uses breadth-first search and a Hash-tree structure to count candidate item sets efficiently, generating candidate item sets, and then pruning the candidates which have an infrequent sub pattern. According to the downward closure lemma, the candidate set contains all frequent-length item sets. After that, it scans the transaction database to determine frequent item sets among the candidates.

The training data 712 includes information on past cases, with their causes and resolutions, the information including data for at least one of the features 702, which are the same, or subset of, the features described with reference to FIG. 6.

The rule-mining model 716 is configured to receive as input 718 a text of the request for self-help and provide an output 720 comprising cases from the database of historical cases and respective scores.

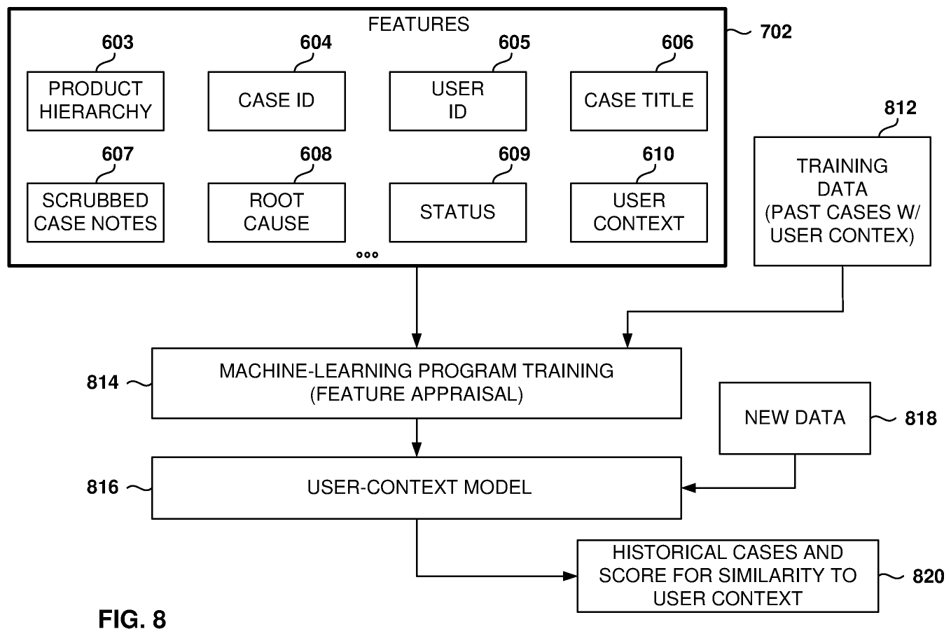

FIG. 8 illustrates the training and use of a machine-learning model for user context, according to some example embodiments. The user-context model 816 is utilized to rate historical cases based on their similarity to the user context. That is, the previous cases in the database where users had a similar context to the context of the current user having a problem.

During training 814 of the ML algorithm, the training data 812 includes information on past cases, including the user contexts of previous users, where the information includes data for at least one of the features 702, which are the same, or subset of, the features described with reference to FIG. 6.

The output 820 of the user-context model 816 is a list of historical cases and a similarity score based on the user context. The similarity score indicates how similar the user context of the new case is to the user context of the case in the database.

The user-context model 816 is configured to receive as input 818 a text of the request for self-help and user context information, and configured to provide an output 820 comprising cases from the database of historical cases and respective scores.

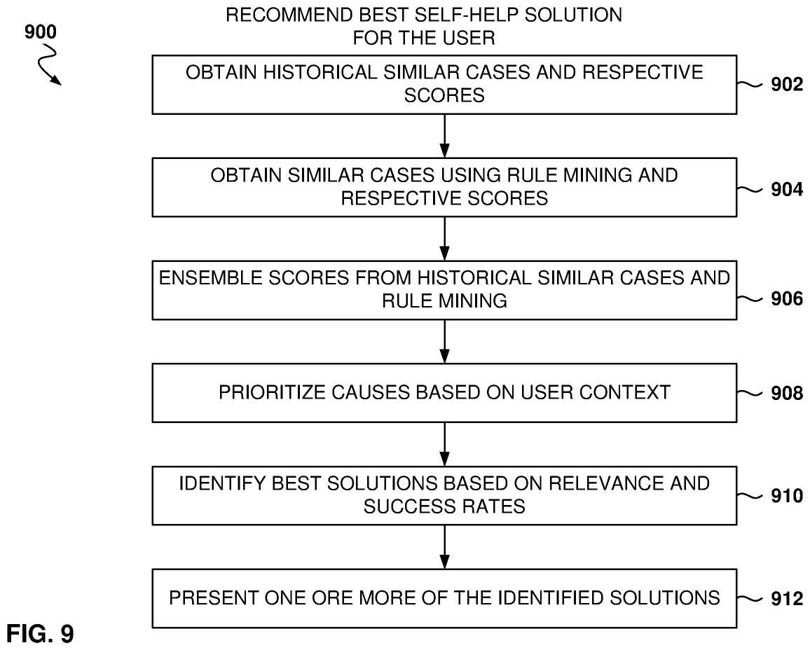

FIG. 9 is a flowchart of a method 900 for recommending self-help solutions, according to some example embodiments. While the various operations in this flowchart are presented and described sequentially, one of ordinary skill will appreciate that some or all of the operations may be executed in a different order, be combined or omitted, or be executed in parallel.

At operation 902, for a given new case associated with a user, the historical similar cases and their respective scores are obtained using the cause model.

From operation 902, the method 900 flows to operation 904 to obtain cases similar to the new case, and their respective scores, using rule mining.

From operation 904, the method 900 flows to operation 906, where the scores from operations 902 and 904 are ensembled into one combined score. That is, a particular case is found at operation 902 with a first score, and the same case is found at operation 904 with a second score, then an ensembled score is calculated based on the first score and the second score. In some example embodiments, the ensembled score is the average of the first score and the second score, and in other embodiments, other operations may be used, such as a weighted average, a geometric average, a maximum, a minimum, etc. If a case appears in a list and not in the other list, the missing score is zero.

At operation 908, the similar cases previously found are prioritized based on the user context, which includes the user information and computing environment information. In some example embodiments, a third score is calculated based on the similarity of a case to the user's context. Then a new combined score is calculated for each potential case based on the previous calculated ensembled score (from the first score and the second score) and the third score. As in the previous operation, an average may be used, but other functions may be used, such as a weighted average, a geometric average, a maximum, a minimum, etc.

At operation 910, a set of the best solutions are identified based on the scores of the previous cases calculated at operation 908, and the respective success rate of each solution. That is, each of the previous cases includes a proposed solution (e.g., recommended self-help) that was presented to the user and the success rate for this presented solution. The success rate is a score that indicates if the proposed solution resolved the problem. In some example embodiments, the success rate is the percentage of times that the solution proposed for a particular case resulted in solving the problem for the user.

By incorporating the information associated with the user, the solutions are better suited for the environment of the user. Additionally, false positives will be reduced, or completely eliminated, by considering the user's environment.

At operation 912, based on the final score of each of the possible solutions, one or more of the identified possible solutions are presented on a display of the user.

Although the embodiments have been described using the information from the three different models, some embodiments may utilize the score provided by any one of the models, or by a combination of two scores provided by two of the models. The embodiments illustrated in FIG. 9 should therefore not be interpreted to be exclusive or limiting, but rather illustrative.

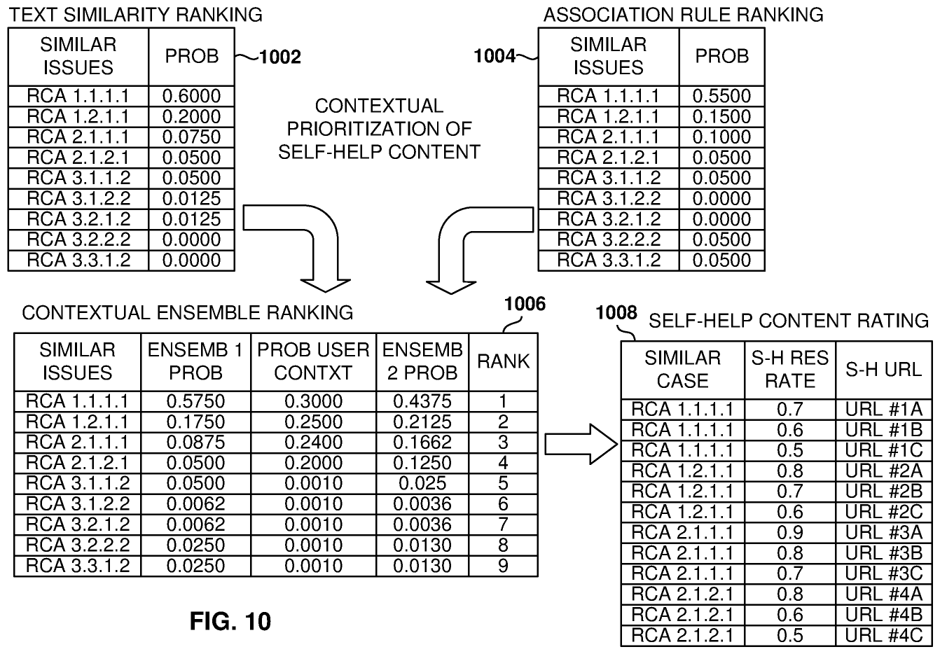

FIG. 10 illustrates the ranking process for selecting self-help options, according to some example embodiments. Table 1002 describes some of the similar issues identified using text similarity, as described above with reference to FIG. 3. Each row includes a case, referred to as a Root Cause Analysis (RCA), and an identifier, such as 1.1.1.1, 1.2.1.1, etc. Further, each RCA has an associated score in the second column of table 1002, which, in this example, the score is the probability that this historical case is a match for the new case (e.g., 0.6000, 0.2000). If a case is not listed, it is assumed that the probability is 0.

Further, table 1004 holds the cases and scores (e.g., probabilities shown in the second column) identified using association rule mining. In this example, case RCA 1.1.1.1 is in table 1002 with a probability 0.6 and in table 1004 with a probability of 0.55. Another example, RCA 3.2.2.2 has a probability of 0 (meaning that this case was not selected) in table 1002 and 0.05 in table 1004.

Table 1006 includes the contextual ensemble ranking by combining information from tables 1002 and 1004. The rows include the RCAs from tables 1002 and 1004, and the second column is an ensemble-1 probability calculated by combining the values from tables 1002 and 1004. In one example embodiment, the ensemble-1 probability is the average of the probabilities from tables 1002 and 1004, but other embodiments may use other calculations like weighted averages, geometric averages, polynomial combinations, maximum, minimum, etc.

The third column in table 1006 is the probability obtained from analyzing the user context, that is, the score obtained by the user-context model for each of the past cases.

The fourth column is for an ensemble-2 probability that combines the values from ensemble 1 and the probability from the user context. In one example embodiment, the ensemble-2 probability is the average of the probabilities from the ensemble 1 and the probability from the user context, but other embodiments may use other calculations like weighted averages, geometric averages, polynomial combinations, maximum, minimum, etc.

Once the ensemble-2 probability is calculated, the table 1006 is sorted based on the ensemble-2 probability (e.g., in descending value order), and the last column indicates the rank from each case, e.g., RCA 1.1.1.1 is ranked #1, RCA 1.2.1.1 is ranked #2, RCA 2.1.1.1 is ranked #3, etc.

By combining the different probabilities obtained by the three different models, the number of false positives is greatly reduced. For example, RCA 3.1.1.2 has a 5% probability for text similarity, but probabilities of 0 for association ranking and 0.1% for user context similarity. The combination guarantees that RCA 3.1.1.2 is not presented to the user as the final probability is 2.5%.

Table 1008 is for self-help content rating and includes a list of cases similar to the new problem of the user. The self-help resolution rate for the previous cases is obtained from the database. There may be more than one possible resolution for a given case, so table 1008 may include more than one entry per case (e.g., three entries for RCA 1.1.1.1 in this example). Each self-help resolution is associated with a self-help URL, shown in the rightmost column, with information on self-help. A list of the top solutions from table 1008 may then be presented to the user with the list of URLs.

In the illustrated example, RCA 1.1.1.1 has three different suggestions for self-help, associated with URLs #1A, #1B, and #1C, with respective resolution rates of 70%, 60%, and 50%. In some example embodiments, minimum resolution rate threshold is used to filter out self-help solutions that do not meet the minimum resolution rate threshold.

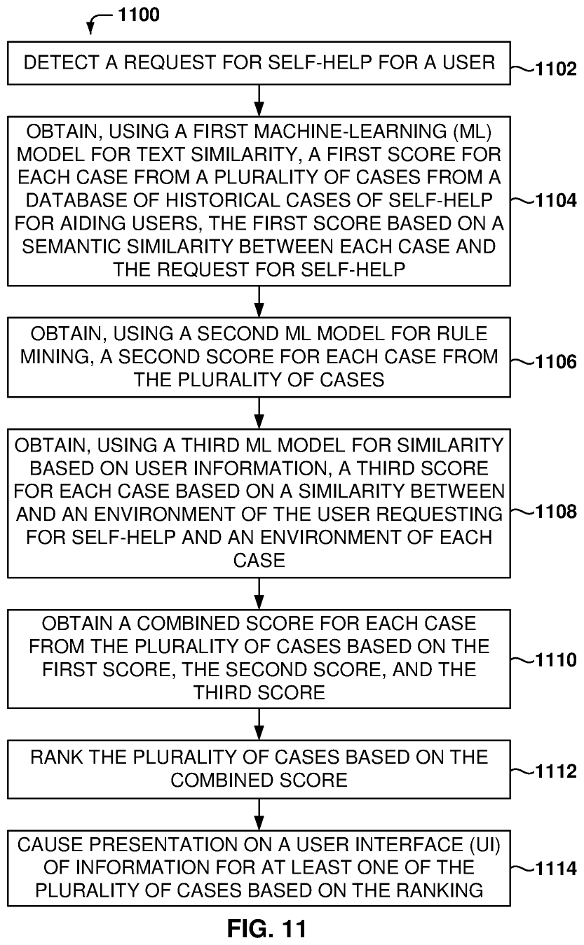

FIG. 11 is a flowchart of a method 1100 for providing automated user self-help, according to some example embodiments. While the various operations in this flowchart are presented and described sequentially, one of ordinary skill will appreciate that some or all of the operations may be executed in a different order, be combined or omitted, or be executed in parallel.

Operation 1102 is for detecting a request for self-help for a user. From operation 1102, the method 1100 flows to operation 1104 for obtaining, using a first machine-learning (ML) model for text similarity, a first score for each case from a plurality of cases from a database of historical cases of self-help for aiding users. The first score is based on a semantic similarity between each case and the request for self-help.

From operation 1104, the method 1100 flows to operation 1106 for obtaining, using a second ML model for rule mining, a second score for each case from the plurality of cases.

From operation 1106, the method 1100 flows to operation 1108 for obtaining, using a third ML model for similarity based on user information, a third score for each case based on a similarity between and an environment of the user requesting for self-help and an environment of each case.

From operation 1108, the method 1100 flows to operation 1110 for obtaining a combined score for each case from the plurality of cases based on the first score, the second score, and the third score.

From operation 1110, the method 1100 flows to operation 1112 for ranking the plurality of cases based on the combined score.

From operation 1112, the method 1100 flows to operation 1114 for causing presentation on a user interface (UI) of information for at least one of the plurality of cases based on the ranking.

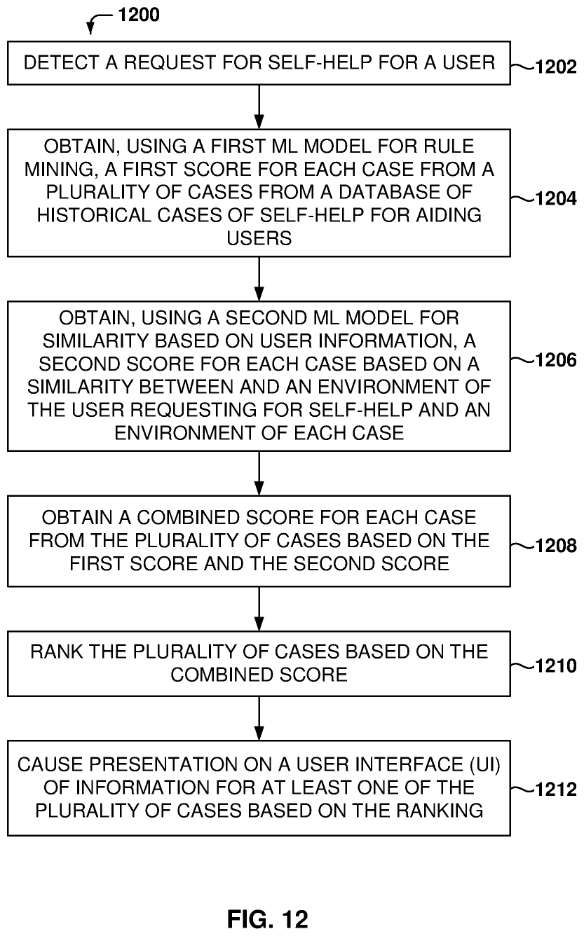

FIG. 12 is a flowchart of another method 1200 for providing automated user self-help, according to some example embodiments. While the various operations in this flowchart are presented and described sequentially, one of ordinary skill will appreciate that some or all of the operations may be executed in a different order, be combined or omitted, or be executed in parallel.

Operation 1202 is for detecting a request for self-help for a user. From operation 1202, the method 1200 flows to operation 1204 for obtaining, using a first ML model for rule mining, a first score for each case from a plurality of cases from a database of historical cases of self-help for aiding users.

From operation 1204, the method 1200 flows to operation 1206 for obtaining, using a second ML model for similarity based on user information, a second score for each case based on a similarity between and an environment of the user requesting for self-help and an environment of each case.

From operation 1206, the method 1200 flows to operation 1208 for obtaining a combined score for each case from the plurality of cases based on the first score and the second score.

From operation 1208, the method 1200 flows to operation 1210 for ranking the plurality of cases based on the combined score.

From operation 1210, the method 1200 flows to operation 1212 for causing presentation on a user interface (UI) of information for at least one of the plurality of cases based on the ranking.

In one example, the method 1200 further comprises obtaining, using a third machine-learning (ML) model for text similarity, a third score for each case from the plurality of cases. The third score is based on a semantic similarity between each case and the request for self-help, and obtaining the combined score is based on the first score, the second score, and the third score.

In one example, the third ML model for text similarity is trained using text from cases previously resolved. The third ML model receives as input a text of the request for self-help and provides an output comprising cases from the database of historical cases and respective scores.

In one example, obtaining the combined score comprises, for each case, obtaining a first ensemble score based on the first score and the third score of the case; and, for each case, obtaining a second ensemble score based on the first ensemble score and the second score of the case.

In one example, ranking the plurality of cases comprises sorting the plurality of cases based on their second ensemble score.

In one example, causing presentation on a UI comprises, for each case presented on the UI, identifying at least one solution for the case, each of the at least one solution having a success rate; selecting solutions based on the success rate of each solution; and causing presentation of information for the selected solutions on the UI.

In one example, a rule-mining algorithm is trained to generate the first ML model for rule mining. The training comprises training data with values for a plurality of features, and the plurality of features comprises product information, user information, case title, case notes, cause of problem, and status.

In one example, the first ML model for rule mining is configured to receive as input a text of the request for self-help and provide an output comprising cases from the database of historical cases and respective scores.

In one example, the second ML model for similarity based on user information is trained using text from cases previously resolved and information on user context for each case, the user context comprising information about the user and information about a computing environment of the user.

In one example, the second model is configured to receive as input a text of the request for self-help and user context information, the second model configured to provide an output comprising cases from the database of historical cases and respective scores.

Another general aspect is for a system that includes a memory comprising instructions and one or more computer processors. The instructions, when executed by the one or more computer processors, cause the one or more computer processors to perform operations comprising: detecting a request for self-help for a user; obtaining, using a first ML model for rule mining, a first score for each case from a plurality of cases from a database of historical cases of self-help for aiding users; obtaining, using a second ML model for similarity based on user information, a second score for each case based on a similarity between and an environment of the user requesting for self-help and an environment of each case; obtaining a combined score for each case from the plurality of cases based on the first score and the second score; ranking the plurality of cases based on the combined score; and causing presentation on a user interface (UI) of information for at least one of the plurality of cases based on the ranking.

In yet another general aspect, a machine-readable storage medium (e.g., a non-transitory storage medium) includes instructions that, when executed by a machine, cause the machine to perform operations comprising: detecting a request for self-help for a user; obtaining, using a first ML model for rule mining, a first score for each case from a plurality of cases from a database of historical cases of self-help for aiding users; obtaining, using a second ML model for similarity based on user information, a second score for each case based on a similarity between and an environment of the user requesting for self-help and an environment of each case; obtaining a combined score for each case from the plurality of cases based on the first score and the second score; ranking the plurality of cases based on the combined score; and causing presentation on a user interface (UI) of information for at least one of the plurality of cases based on the ranking.

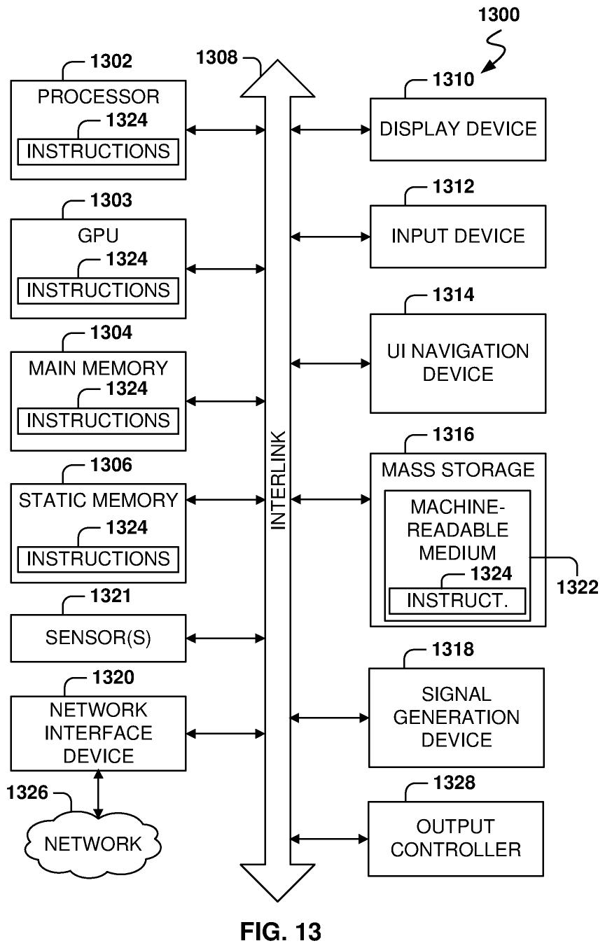

FIG. 13 is a block diagram illustrating an example of a machine 1300 upon or by which one or more example process embodiments described herein may be implemented or controlled. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in a peer-to-peer (P2P) (or other distributed) network environment. Further, while only a single machine 1300 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1300 may include a hardware processor 1302 (e.g., a central processing unit (CPU), a hardware processor core, or any combination thereof), a graphics processing unit (GPU) 1303, a main memory 1304, and a static memory 1306, some or all of which may communicate with each other via an interlink (e.g., bus) 1308. The machine 1300 may further include a display device 1310, an alphanumeric input device 1312 (e.g., a keyboard), and a user interface (UI) navigation device 1314 (e.g., a mouse). In an example, the display device 1310, alphanumeric input device 1312, and UI navigation device 1314 may be a touch screen display. The machine 1300 may additionally include a mass storage device (e.g., drive unit) 1316, a signal generation device 1318 (e.g., a speaker), a network interface device 1320, and one or more sensors 1321, such as a Global Positioning System (GPS) sensor, compass, accelerometer, or another sensor. The machine 1300 may include an output controller 1328, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1316 may include a machine-readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, within the hardware processor 1302, or within the GPU 1303 during execution thereof by the machine 1300. In an example, one or any combination of the hardware processor 1302, the GPU 1303, the main memory 1304, the static memory 1306, or the mass storage device 1316 may constitute machine-readable media.

While the machine-readable medium 1322 is illustrated as a single medium, the term “machine-readable medium” may include a single medium, or multiple media, (e.g., a centralized or distributed database, and/or associated caches and servers) configured to store the one or more instructions 1324.

The term “machine-readable medium” may include any medium that is capable of storing, encoding, or carrying instructions 1324 for execution by the machine 1300 and that cause the machine 1300 to perform any one or more of the techniques of the present disclosure, or that is capable of storing, encoding, or carrying data structures used by or associated with such instructions 1324. Non-limiting machine-readable medium examples may include solid-state memories, and optical and magnetic media. In an example, a massed machine-readable medium comprises a machine-readable medium 1322 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
detecting a request for self-help for a user;
obtaining, using a first ML model for rule mining, a first score for each case from a plurality of cases from a database of historical cases of self-help for aiding users;
obtaining, using a second ML model for similarity based on user information, a second score for each case based on a similarity between and an environment of the user requesting for self-help and an environment of each case;
obtaining a combined score for each case from the plurality of cases based on the first score and the second score;
ranking the plurality of cases based on the combined score; and
causing presentation on a user interface (UI) of information for at least one of the plurality of cases based on the ranking.

2. The method as recited in claim 1, further comprising:
obtaining, using a third machine-learning (ML) model for text similarity, a third score for each case from the plurality of cases, the third score based on a semantic similarity between each case and the request for self-help, wherein obtaining the combined score is based on the first score, the second score, and the third score.

3. The method as recited in claim 2, wherein the third ML model for text similarity is trained using text from cases previously resolved, the third ML model receiving as input a text of the request for self-help and providing an output comprising cases from the database of historical cases and respective scores.

4. The method as recited in claim 2, wherein obtaining the combined score comprises:
for each case, obtaining a first ensemble score based on the first score and the third score of the case; and
for each case, obtaining a second ensemble score based on the first ensemble score and the second score of the case.

5. The method as recited in claim 4, wherein ranking the plurality of cases comprises:
sorting the plurality of cases based on their second ensemble score.

6. The method as recited in claim 1, wherein causing presentation on a UI comprises:
for each case presented on the UI, identifying at least one solution for each case, each of the at least one solution having a success rate;
selecting solutions based on the success rate of each solution; and
causing presentation of information for the selected solutions on the UI.

7. The method as recited in claim 1, wherein a rule-mining algorithm is trained to generate the first ML model for rule mining, the training comprising training data with values for a plurality of features, the plurality of features comprising product information, user information, case title, case notes, cause of problem, and status.

8. The method as recited in claim 1, wherein the first ML model for rule mining is configured to receive as input a text of the request for self-help and provide an output comprising cases from the database of historical cases and respective scores.

9. The method as recited in claim 1, wherein the second ML model for similarity based on user information is trained using text from cases previously resolved and information on user context for each case, the user context comprising information about the user and information about a computing environment of the user.

10. The method as recited in claim 1, wherein the second model is configured to receive as input a text of the request for self-help and user context information, the second model configured to provide an output comprising cases from the database of historical cases and respective scores.

11. A system comprising:
a memory comprising instructions; and
one or more computer processors, wherein the instructions, when executed by the one or more computer processors, cause the system to perform operations comprising:
detect a request for self-help for a user;
obtain, using a first ML model for rule mining, a first score for each case from a plurality of cases from a database of historical cases of self-help for aiding users;
obtain, using a second ML model for similarity based on user information, a second score for each case based on a similarity between and an environment of the user requesting for self-help and an environment of each case;
obtain a combined score for each case from the plurality of cases based on the first score and the second score;
rank the plurality of cases based on the combined score; and
cause presentation on a user interface (UI) of information for at least one of the plurality of cases based on the ranking.

12. The system as recited in claim 11, wherein the instructions further cause the one or more computer processors to perform operations comprising:
obtain, using a third machine-learning (ML) model for text similarity, a third score for each case from the plurality of cases, the third score based on a semantic similarity between each case and the request for self-help, wherein obtaining the combined score is based on the first score, the second score, and the third score.

13. The system as recited in claim 12, wherein the third ML model for text similarity is trained using text from cases previously resolved, the third ML model receiving as input a text of the request for self-help and providing an output comprising cases from the database of historical cases and respective scores.

14. The system as recited in claim 12, wherein obtaining the combined score comprises:
for each case, obtaining a first ensemble score based on the first score and the third score of the case; and
for each case, obtaining a second ensemble score based on the first ensemble score and the second score of the case.

15. The system as recited in claim 14, wherein ranking the plurality of cases comprises:
sorting the plurality of cases based on their second ensemble score.

16. A tangible machine-readable storage medium including instructions that, when executed by a machine, cause the machine to perform operations comprising:
detecting a request for self-help for a user;
obtaining, using a first ML model for rule mining, a first score for each case from a plurality of cases from a database of historical cases of self-help for aiding users;
obtaining, using a second ML model for similarity based on user information, a second score for each case based on a similarity between and an environment of the user requesting for self-help and an environment of each case;
obtaining a combined score for each case from the plurality of cases based on the first score and the second score;
ranking the plurality of cases based on the combined score; and
causing presentation on a user interface (UI) of information for at least one of the plurality of cases based on the ranking.

17. The tangible machine-readable storage medium as recited in claim 16, wherein the machine further performs operations comprising:
obtaining, using a third machine-learning (ML) model for text similarity, a third score for each case from the plurality of cases, the third score based on a semantic similarity between each case and the request for self-help, wherein obtaining the combined score is based on the first score, the second score, and the third score.

18. The tangible machine-readable storage medium as recited in claim 17, wherein the third ML model for text similarity is trained using text from cases previously resolved, the third ML model receiving as input a text of the request for self-help and providing an output comprising cases from the database of historical cases and respective scores.

19. The tangible machine-readable storage medium as recited in claim 17, wherein obtaining the combined score comprises:
for each case, obtaining a first ensemble score based on the first score and the third score of the case; and
for each case, obtaining a second ensemble score based on the first ensemble score and the second score of the case.

20. The tangible machine-readable storage medium as recited in claim 19, wherein ranking the plurality of cases comprises:
sorting the plurality of cases based on their second ensemble score.
